(19) United States
(12) Patent Application Publication
(10) Pub. No.: US 2023/0214741 A1
(43) Pub. Date: Jul. 6, 2023

(54) INTELLIGENT PARTICIPANT MATCHING AND ASSESSMENT ASSISTANT

(71) Applicant: International Business Machines Corporation, Armonk, NY (US)

(72) Inventors: Jennifer M. Hatfield, San Francisco, CA (US); EWA KARWETA, New York, NY (US); Ourania Svoronou, New York, NY (US); Danielle Espine, Jamaica, NY (US); Lucia Larise Stavarache, Columbus, OH (US)

(21) Appl. No.: 17/569,638

(22) Filed: Jan. 6, 2022

(51) Int. Cl. G06Q 10/06; G06Q 10/10

(52) U.S. Cl. CPC G06Q 10/063118; G06Q 10/103; G06Q 10/063116; G06Q 10/063112

(57) ABSTRACT

An approach for optimizing the selection of team members on a project team. The approach retrieves data associated with prospective members of a project team. The approach generates team member personality scores based on a machine learning model. The approach generates a team compatibility score based on a portion of the prospective team member personality scores. The approach calculates a predicted project success score based on the team compatibility score. The approach assigns prospective team members to the team based on maximizing the predicted project success score.

### TECHNICAL FIELD

The present invention relates generally to workplace efficiency, and specifically, to workplace team creation optimization.

### B ACKGROUND

Uncomfortable and inefficient workplaces are created when people are not performing or communicating at their best due to personality and/or work method conflicts. This ineffective interaction can result in low team morale, risk for project schedules and unhappy customers/clients. When working in a team environment, some personality types are better suited to work together than other personality types. Accordingly, when the wrong personality types are matched for a team, a level of friction can be developed between team members which in turn can undermine project efficiency by discouraging team members from performing at their highest levels. Further, pairings of manager to employee and mentoring relationships are sub-optimal when there is friction in work methods and/or communication styles.

### BRIEF SUMMARY

According to an embodiment of the present invention, a computer-implemented method for optimizing the selection of team members on a project team, the computer-implemented method comprising: retrieving, by one or more processors, data associated with prospective members of a project team; generating, by the one or more processors, team member personality scores associated with the prospective team members based on a machine learning model and the data; generating, by the one or more processors, a team compatibility score based on personality scores of a portion of the prospective team members; calculating, by the one or more processors, a predicted project success score based on the team compatibility score; and assigning, by the one or more processors, prospective team members to the team based on maximizing the predicted project success score.

According to an embodiment of the present invention, a computer program product for optimizing the selection of team members on a project team, the computer program product comprising: one or more non-transitory computer readable storage media and program instructions stored on the one or more non-transitory computer readable storage media, the program instructions comprising: program instructions to, retrieve data associated with prospective members of a project team; program instructions to, generate member personality scores associated with the prospective team members based on a machine learning model and the data; program instructions to, generate a team compatibility score based on personality scores of a portion of the prospective team members; program instructions to, calculate a predicted project success score based on the team compatibility score; and program instructions to, assign prospective team members to the team based on maximizing the predicted project success score.

According to an embodiment of the present invention, a computer system for optimizing the selection of team members on a project team, the computer system comprising: one or more computer processors; one or more non-transitory computer readable storage media; and program instructions stored on the one or more non-transitory computer readable storage media, the program instructions comprising: program instructions to, retrieve data associated with prospective members of a project team; program instructions to, generate member personality scores associated with the prospective team members based on a machine learning model and the data; program instructions to, generate a team compatibility score based on personality scores of a portion of the prospective team members; program instructions to, calculate a predicted project success score based on the team compatibility score; and program instructions to, assign prospective team members to the team based on maximizing the predicted project success score.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, according to embodiments of the present invention.

FIG. 2 depicts abstraction model layers, according to embodiments of the present invention.

FIG. 3 is a high-level architecture, according to embodiments of the present invention.

FIG. 4 is an exemplary detailed architecture, according to embodiments of the present invention.

FIG. 5 is a flowchart of a method, according to embodiments of the present invention.

FIG. 6 is a block diagram of internal and external components of a data processing system in which embodiments described herein may be implemented, according to embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of optimizing workplace team efficiency based on minimizing team member conflicts. Embodiments of the present invention can determine optimum team staffing based on factors such as, but not limited to, team member personality traits, historic team interaction patterns, predicted behaviors, sentiment, etc. Interval team adjustments and individual insights from a cognitive analysis can optimize both team and individual performance. It should be noted that these embodiments are applicable not only to team forming but also to managerial relationships and mentor/coach relationships.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

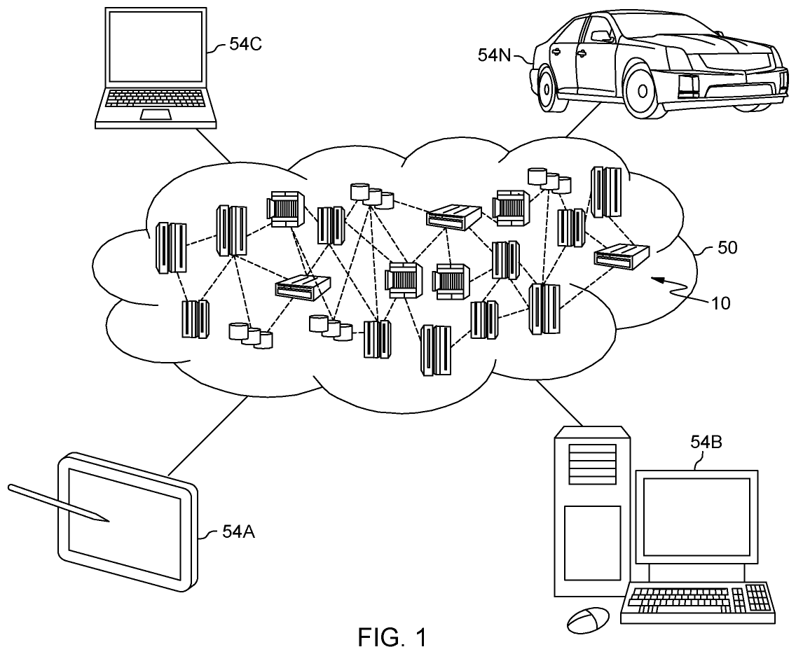

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

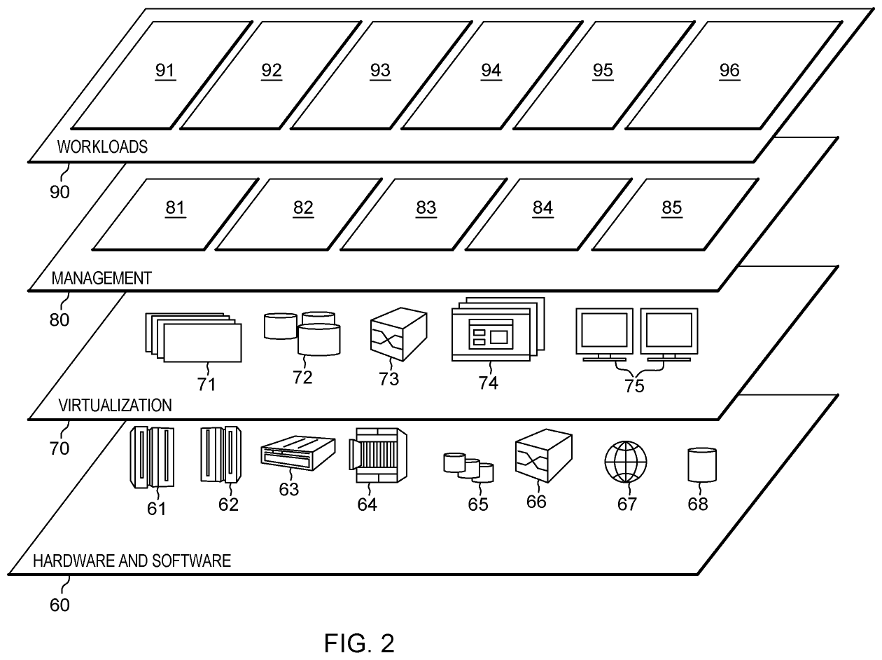

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and team member management 96.

It should be noted that the embodiments of the present invention may operate with a user's permission. Any data may be gathered, stored, analyzed, etc., with a user's consent. In various configurations, at least some of the embodiments of the present invention are implemented into an opt-in application, plug-in, etc., as would be understood by one having ordinary skill in the art upon reading the present disclosure.

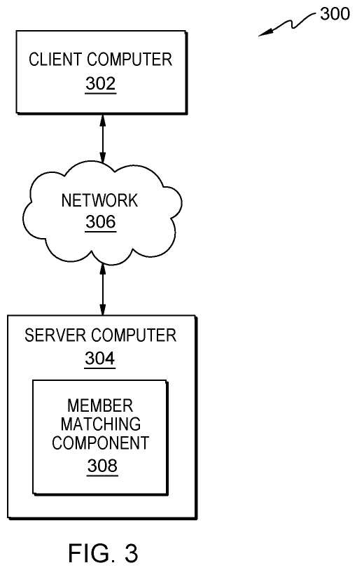

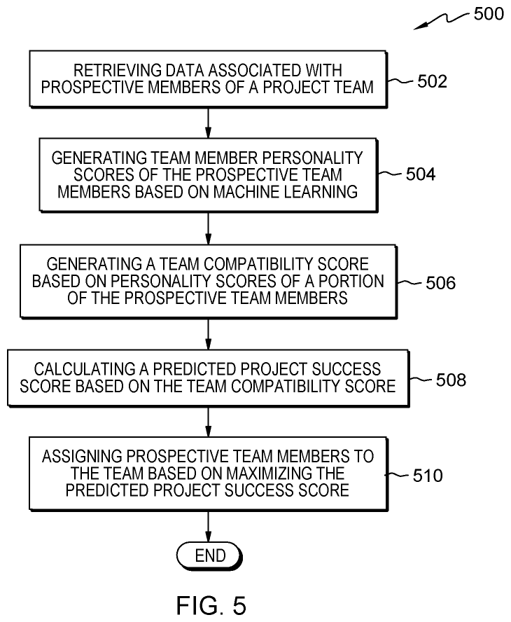

FIG. 3 is a high-level architecture for performing various operations of FIG. 5, in accordance with various embodiments. The architecture 300 may be implemented in accordance with the present invention in any of the environments depicted in FIGS. 1-4, among others, in various embodiments. Of course, more or less elements than those specifically described in FIG. 3 may be included in architecture 300, as would be understood by one of ordinary skill in the art upon reading the present descriptions.

Each of the steps of the method 500 (described in further detail below) may be performed by any suitable component of the architecture 300. A processor, e.g., processing circuit(s), chip(s), and/or module(s) implemented in hardware and/or software, and preferably having at least one hardware component may be utilized in any device to perform one or more steps of the method 500 in the architecture 300. Illustrative processors include, but are not limited to, a central processing unit (CPU), an application specific integrated circuit (ASIC), a field programmable gate array (FPGA), etc., combinations thereof, or any other suitable computing device known in the art.

Architecture 300 includes a block diagram, showing a storage optimization system, to which the invention principles may be applied. The architecture 300 comprises a client computer 302, a member matching component 308 operational on a server computer 304 and a network 306 supporting communication between the client computer 302 and the server computer 304.

Client computer 302 can be any computing device on which software is installed for which an update is desired or required. Client computer 302 can be a standalone computing device, management server, a web server, a mobile computing device, or any other electronic device or computing system capable of receiving, sending, and processing data. In other embodiments, client computer 302 can represent a server computing system utilizing multiple computers as a server system. In another embodiment, client computer 302 can be a laptop computer, a tablet computer, a netbook computer, a personal computer, a desktop computer or any programmable electronic device capable of communicating with other computing devices (not shown) within user persona generation environment via network 306.

In another embodiment, client computer 302 represents a computing system utilizing clustered computers and components (e.g., database server computers, application server computers, etc.) that act as a single pool of seamless resources when accessed within install-time validation environment of architecture 300. Client computer 302 can include internal and external hardware components, as depicted and described in further detail with respect to FIG. 5.

Server computer 304 can be a standalone computing device, management server, a web server, a mobile computing device, or any other electronic device or computing system capable of receiving, sending, and processing data. In other embodiments, server computer 304 can represent a server computing system utilizing multiple computers as a server system. In another embodiment, server computer 304 can be a laptop computer, a tablet computer, a netbook computer, a personal computer, a desktop computer, or any programmable electronic device capable of communicating with other computing devices (not shown) within install-time validation environment of architecture 300 via network 306.

Network 306 can be, for example, a local area network (LAN), a wide area network (WAN) such as the Internet, or a combination of the two, and can include wired, wireless, or fiber optic connections. In general, network 306 can be any combination of connections and protocols that will support communications between client computer 302 and server computer 304.

In one embodiment of the present invention, member matching component 308, operational on server computer 304, can create a rating of how well team member personalities match. It should be noted that a team member must provide consent to the use of these embodiments before use and must provide preferences to create an anonymized token.

In another embodiment of the present invention, member matching component 308 can retrieve historical team interaction data from a server. For example, historical data can be retrieved of team interactions while assigned to previous teams. It should be noted that this historical data can include, but is not limited to, personality analysis and profiles from previous teams, team conflicts, conflict resolutions, etc.

In another aspect of an embodiment of the present invention, member matching component 308 can predict team compatibility and performance based on the personality analysis and historical data. In another aspect of an embodiment of the present invention, member matching component 308 can provide indications of where team conflict may develop and approaches to resolve the conflict.

Other aspects of member matching component 308 can include, but are not limited to, allowing team members to “opt-in” to the team analysis for personality testing and ongoing assessments. In one aspect, the “opt-in” can be accomplished through a digital interface before taking a standard personality measurement test, e.g., a Myers-Briggs test. It should be noted that “opt-in” can include, but is not limited to, ongoing assessments associated with the compatibility of a first team member's personality type with a second team member's personality type, plus, monitoring team member dynamics for inclusion in a machine learning model, optimization predictions, recommendations, and adjustments.

In another aspect of an embodiment, a machine learning model, as described above, can account for at least two scores, a general aggregated team score and an individual score. It should be noted that these scores are directly dependant. In another aspect of an embodiment, as projects scale up and down their resource needs can change e.g., need more architecting and design early in a project and need more development and testing later in a project. Accordingly, member matching component 308 can balance the model as team member contribution changes.

In another aspect of an embodiment, the machine learning model can provide machine learning of an individual's personality traits and collaborative style based on ingesting personality test results and historical records of collaborative style. In another aspect of an embodiment, as a team member is assigned to an activity, member matching component 308 can consider them actively participating. Accordingly, team members can be tracked as participating based on factors such as, but not limited to, verbal communications, physical movements, sensor tracking, e.g., sensor attached to a team member, eye tracking, microphone and/or a camera recording vocal sentiment, etc. In another aspect of an embodiment, team members can be manually assigned, and historical patterns and behavior can be accessed from a data corpus if available.

In another aspect of an embodiment, the machine learning model can identify common parameters for measuring differences between team members based on different personalities, wherein member matching component 308 can record the identified personality traits on a team member basis from the personality test results. Further, member matching component 308 can measure and record team member activities, collaboration style and participation and how a team member changes behavior based on an interaction with a team member have a different type of personality, e.g., if an interacting team member is loud and a subject team member becomes quieter as a result. It should be noted that member matching component 308 can identify gaps between team members of both like personality and different personality and can adjust between the personality test results and observed behavior.

In another aspect of an embodiment, the machine learning model can be used to increase resolution for understanding common differences between team members with a “same” personality type based on identifying sub-groups within the “same” type, e.g., as the machine learning model is taught distinctions between team members of the “same” personality type, member matching component 308 can identify sub-groups within a specific group. The machine learning model can be taught to focus on specific areas where sub-groups play a greater factor in group dynamics and assignment to a group by focusing on group dynamics, collaborative style, communication style and work preferences.

In another aspect of an embodiment, member matching component 308 can recommend pairings of team members to form a team or teams to complete a project based on an analysis and assign success rating to the recommendation. Based on scenario modeling insights, a success rating score and/or a confidence score can be assigned to indicate the team pairing is optimal. It should be noted that additional recommendations are provided at the end of a modeling scenario for team member adjustments and/or team refinements, e.g., based on team progress.

In another aspect of an embodiment, member matching component 308 can assess the recommendations and predict outcomes based on real data. It should be noted that the success rating can be updated and reported based on the assessment. In another aspect of an embodiment, as the team collaborates, member matching component 308 can continuously learn from observations of collaboration styles, personality matches, etc. wherein the observations can be accomplished using cameras for direct team member interactions and virtual meeting video, e.g., WebEx, for meeting interactions. It should be noted that a cognitive engine can be trained through various team exercises to learn team dynamics and continuously evaluate the rating assigned by member matching component 308 and adjustments can be made to the rating by the cognitive engine and provided to a team lead with recommendations for adjustments to optimize the team.

In another aspect of an embodiment of the present invention, a machine learning model can be trained based on inputs including, but not limited to team member personality, team member skill and team member historical project performance and success. A team member personality input can include but is not limited to, a personality test, a work social indicator, e.g., coaching, mentoring, buddy system, internal training, etc., a peer evaluation or recognition, and an external presence, e.g., sharing/training outside the organization. A team member skill input can include, but is not limited to, competencies, e.g., level of programming capability and breadth of programming language knowledge, and applied skills, e.g., latest applied skills of a team member in the team member's most recent projects. A team member historical project performance and success can include, but is not limited to, a measure of team member successful initiative executions in recent projects and a measure of team member successful similar roles.

In another aspect of an embodiment of the present invention, the machine learning model can be based on weighted factors. For example, a machine learning model can be weighted as 50% weighted team member personality score, a 20% weighted team member skill score and a 30% weighted team member historical team score. It should be noted that a machine learning model can be based on other factors and other percentages based on a team leader or manager's desired configuration.

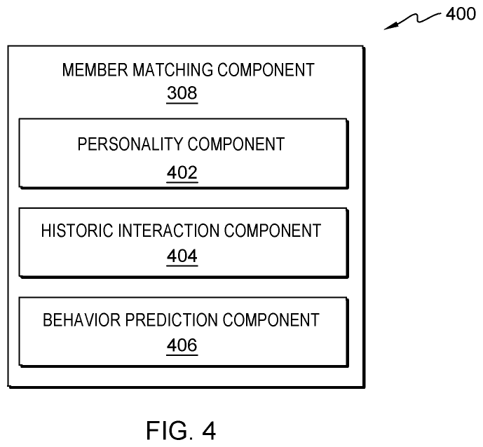

FIG. 4 is an exemplary detailed architecture for performing various operations of FIG. 5, in accordance with various embodiments. The architecture 400 may be implemented in accordance with the present invention in any of the environments depicted in FIGS. 1-3 and 5, among others, in various embodiments. Of course, a different number of elements than those specifically described in FIG. 4 may be included in architecture 400, as would be understood by one of skill in the art upon reading the present descriptions.

Each of the steps of the method 500 (described in further detail below) may be performed by any suitable component of the architecture 400. A processor, e.g., processing circuit(s), chip(s), and/or module(s) implemented in hardware and/or software, and preferably having at least one hardware component, may be utilized in any device to perform one or more steps of the method 500 in the architecture 400. Illustrative processors include, but are not limited to, a central processing unit (CPU), an application specific integrated circuit (ASIC), a field programmable gate array (FPGA), etc., combinations thereof, or any other suitable computing device known in the art.

Architecture 400 provides a detailed view of at least some of the modules of architecture 300. Architecture 400 can comprise a member matching component 308, which can further comprise a personality component 402, a historic interaction component 404 and a behavior prediction component 406.

In one aspect of an embodiment of the present invention, personality component 402 can create a persona for team members. It should be noted that the persona creation can begin when a team member joins the organization and can be updated as the team member moves from team to team and/or project to project. A persona can be described as a business persona defined at the organizational level, e.g., project manager, developer, designer, tester, etc. and can be a high-level persona mapped on the type of business the organization is performing.

A persona can be created based on factors such as, but not limited to, role, operating geographies, working type, e.g., remote/collocated, years in profession, years in job role, years in organization, etc. It should be noted that the persona does not include any personal identifiable information and is primarily used to identify persona patterns at the organization level to help organizations assess their workforce and better understand their organizational culture from at different levels of the organization. It should further be noted that an individual can have different personas for different projects.

In another aspect of an embodiment of the present invention, personality component 402 can engage the individual to take an associated personality test, e.g., Meyers-Briggs test, that can vary as each organization/culture is different. It should be noted that the personality test does not necessarily need to be the same, however it should reflect, without intrusiveness, work/team dynamics to be evaluated. In another aspect of an embodiment of the present invention, personality component 402 can assimilate the results of the personality test to create/update a persona, including, creating an avatar representing the personal if desired and send the results to historic interaction component 404.

In another aspect of an embodiment of the present invention, historic interaction component 404 can provide the capability to organize and store the results based on the one or more personas associated with an individual. Historical interaction component can provide personas, upon request, to behavior prediction component 406 for cognitive analysis. It should be noted that historic interaction component 404 can store the personas locally and and/or on a remote storage device.

In one aspect of an embodiment of the present invention, behavior prediction component 406 can provide the capability for individual assessments based on persona tests, historical inputs (if any), and real-time observations of an individual. In another aspect of an embodiment of the present invention, behavior prediction component 406 can incorporate real-time observations of an individual for pairing with other individuals in a team for a project and the co-workers can give feedback or provide impromptu observations, e.g., the system will ask agnostically of the individual or task, can you score your communication satisfaction, from 1-5, with team member “avatar name.” It should be noted that impromptu observations can be derived by factors such as, but not limited to, answers from team members that imply there are problems in the team, project performance, management queries, milestones checkpoints, etc.

In another aspect of an embodiment of the present invention, behavior prediction component 406 can receive anonymized avatars of team members and can compute a general health score, representing the health of the team, and a productivity score, representing the productivity of the team. Behavior prediction component 406 can generate a report comprising project milestones, a completeness indication, the general health score, and the productivity score.

In another embodiment of the present invention, behavior prediction component 406 can, based on the real-time observations described previously, provide continuous monitoring of team members, maintaining a “health check” of the team and the team members. Behavior prediction component 406 can model teams and parings of team members and provide cognitive assessment of the teams. Behavior prediction component 406 can provide modeling results of as output, e.g., predictions based on inputs and whether the team optimization was successful or unsuccessful. In another aspect of the embodiment, behavior prediction component 406 can recommend adjustments to optimize a team. It should be noted that as a project proceeds, behavior prediction component 406 can recommend predicted adjustments to further optimize the team's performance.

FIG. 5 is an exemplary flowchart of a method 500 for optimizing the selection of team members on a project team. At step 502, an embodiment can retrieve, via member matching component 308, data associated with prospective members of a project team. At step 504, the embodiment can generate, via personality component 402, personality scores of the prospective team member via machine learning. At step 506, the embodiment can generate, via historic interaction component 404, a team compatibility score based on personality scores of a portion of the prospective team members. At step 508, the embodiment can calculate, via behavior prediction component 406, a predicted project success score based on the team compatibility score. At step 510, the embodiment can assign, via member matching component 308, prospective team members to the team based on maximizing the predicted project success score, e.g., as a percentage of project completion and/or at projection completion.

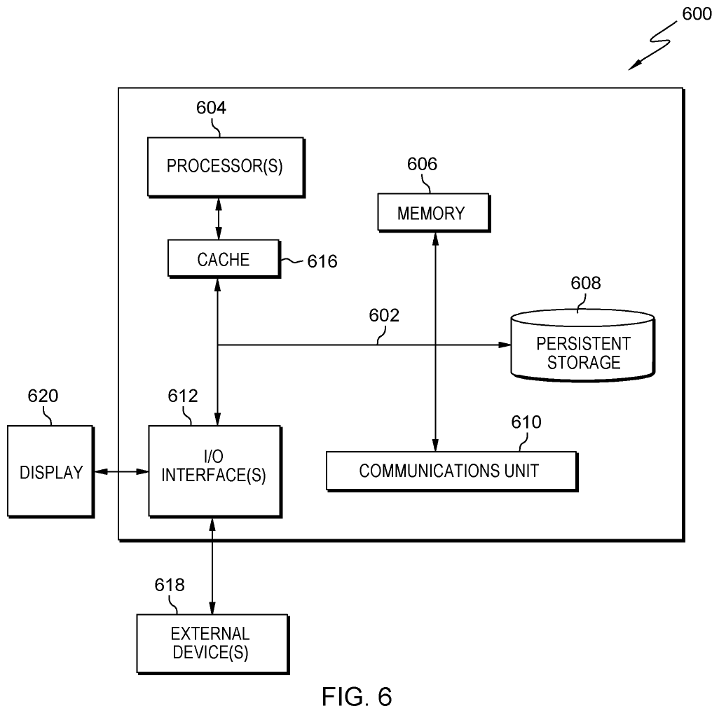

FIG. 6 depicts computer system 600, an example computer system representative of client computer 302 and server computer 304. Computer system 600 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Computer system 600 includes processors 604, cache 616, memory 606, persistent storage 608, communications unit 610, input/output (I/O) interface(s) 612 and communications fabric 602. Communications fabric 602 provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of processors 604 by holding recently accessed data, and data near recently accessed data, from memory 606.

Program instructions and data used to practice embodiments of the present invention may be stored in persistent storage 608 and in memory 606 for execution by one or more of the respective processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Program instructions and data used to practice embodiments of the present invention may be downloaded to persistent storage 608 through communications unit 610.

I/O interface(s) 612 allows for input and output of data with other devices that may be connected to each computer system. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention can be stored on such portable computer readable storage media and can be loaded onto persistent storage 608 via I/O interface(s) 612. I/O interface(s) 612 also connect to display 620.

Display 620 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing a selection of team members on a project team, the computer-implemented method comprising:
retrieving, by one or more processors, data associated with prospective team members of a project team;
generating, by the one or more processors, team member personality scores associated with the prospective team members based on a machine learning model and the data;
generating, by the one or more processors, a team compatibility score based on personality scores of a portion of the prospective team members;
calculating, by the one or more processors, a predicted project success score based on the team compatibility score; and
assigning, by the one or more processors, prospective team members to the project team based on maximizing the predicted project success score.

2. The computer-implemented method of claim 1, further comprising:
calculating, by the one or more processors, an updated predicted project success score based on analyzing team progress with respect to project completion; and
adjusting, by the one or more processors, team members based on the updated predicted project success score.

3. The computer-implemented method of claim 1, wherein the data comprises personality data, historical team member interaction data and real-time team member interaction observations.

4. The computer-implemented method of claim 1, wherein the personality score is based on a Myers-Briggs personality test.

5. The computer-implemented method of claim 2, wherein the data is stored in a team member profile.

6. The computer-implemented method of claim 1, wherein the machine learning model is based on a 50% weighted team member personality score, a 20% weighted team member skill score and a 30% weighted team member historical team score.

7. The computer-implemented method of claim 6, wherein the skill score is based on team member training and team member applied skills, and the historical team score is based on similar projects and similar roles.

8. A computer program product for optimizing a selection of team members on a project team, the computer program product comprising:
one or more non-transitory computer readable storage media and program instructions stored on the one or more non-transitory computer readable storage media, the program instructions comprising:
program instructions to, retrieve data associated with prospective team members of a project team;
program instructions to, generate member personality scores associated with the prospective team members based on a machine learning model and the data;
program instructions to, generate a team compatibility score based on personality scores of a portion of the prospective team members;
program instructions to, calculate a predicted project success score based on the team compatibility score; and
program instructions to, assign prospective team members to the project team based on maximizing the predicted project success score.

9. The computer program product of claim 8, further comprising:
program instructions to, calculate an updated predicted project success score based on analyzing team progress with respect to project completion; and
program instructions to, adjust team members based on the updated predicted project success score.

10. The computer program product of claim 8, wherein the data comprises personality data, historical team member interaction data and real-time team member interaction observations.

11. The computer program product of claim 8, wherein the personality score is based on a Myers-Briggs personality test.

12. The computer program product of claim 9, wherein the data is stored in a team member profile.

13. The computer program product of claim 8, wherein the machine learning model is based on a 50% weighted team member personality score, a 20% weighted team member skill score and a 30% weighted team member historical team score.

14. The computer program product of claim 13, wherein the skill score is based on team member training and team member applied skills, and the historical team score is based on similar projects and similar roles.

15. A computer system for optimizing a selection of team members on a project team, the computer system comprising:
one or more computer processors;
one or more non-transitory computer readable storage media; and
program instructions stored on the one or more non-transitory computer readable storage media, the program instructions comprising:
program instructions to, retrieve data associated with prospective team members of a project team;
program instructions to, generate member personality scores associated with the prospective team members based on a machine learning model and the data;
program instructions to, generate a team compatibility score based on personality scores of a portion of the prospective team members;
program instructions to, calculate a predicted project success score based on the team compatibility score; and
program instructions to, assign prospective team members to the project team based on maximizing the predicted project success score.

16. The computer system of claim 15, further comprising:
program instructions to, calculate an updated predicted project success score based on analyzing team progress with respect to project completion; and
program instructions to, adjust team members based on the updated predicted project success score.

17. The computer system of claim 15, wherein the data comprises personality data, historical team member interaction data and real-time team member interaction observations.

18. The computer system of claim 15, wherein the personality score is based on a Myers-Briggs personality test.

19. The computer system of claim 16, wherein the data is stored in a team member profile.

20. The computer system of claim 15, wherein the machine learning model is based on a 50% weighted team member personality score, a 20% weighted team member skill score comprising team member training and team member applied skills, and a 30% weighted team member historical team score comprising similar projects and similar roles.
